(19) United States
(12) Patent Application Publication
(10) Pub. No.: US 2015/0161563 A1
(43) Pub. Date: Jun. 11, 2015

(54) Systems and Methods for Crowdsourced Shipping

(71) Applicant: Crowdshipping, Inc., Beverly Hills, CA (US)

(72) Inventor: Kevin Mehrabi, Beverly Hills, CA (US)

(73) Assignee: Crowdshipping, Inc., Beverly Hills, CA (US)

(21) Appl. No.: 14/100,936

(22) Filed: Dec. 9, 2013

(51) Int. Cl. G06Q 10/08

(52) U.S. Cl. CPC G06Q 10/08355

(57) ABSTRACT

A method including receiving a shipping need including a destination from a customer, receiving spatiotemporal information for each of a plurality of runners, generating one or more travel routes for each of the plurality of runners, identifying one or more customer opportunities for the shipping need, and selecting one of the one or more customer opportunities for fulfilling the shipping need is provided. The travel routes may be generated based, at least in part, on the spatiotemporal information. Each of the customer opportunities may be identified based, at least in part, on an intersection of at least a portion of the one or more travel routes and the destination, within a predetermined spatiotemporal deviation.

### BACKGROUND

Various types of shipping systems and methods are known in the art. In a traditional shipping system, a customer places a request to a shipment carrier to transport an item from an origin location to a destination for a fee. Often, the customer must either remit the item at certain pre-set package drop-off locations by a certain time of day, or pay an additional fee to have the carrier pick up the package from a location chosen by the user. Such shipping systems may also have strict requirements on how items must be packaged and limitations on the types of items that may be shipped.

The fee charged to a customer often depends on the size and weight of the item being shipped, the distance between the origin and destination, and the delivery speed and timing requirements set by the user. Generally, the faster a customer wants the item delivered, the higher the shipment fee. Shipping carriers or delivery services typically have dedicated vehicles, receiving and sorting facilities, and employees for transporting the items and, therefore, may bear significant overhead that must be passed on to users in the form of shipping fees. In fact, the fee charged for next-day delivery may be cost-prohibitive to many users. Further, most shipping carriers or delivery services do not offer same-day shipping services and may provide only limited delivery service in some locations. With the amount of oversight required to coordinate shipment of goods in these traditional systems, reliability and timeliness are difficult to achieve.

Accordingly, users may benefit from a system that is able to provide accessible and affordable same-day shipping services. Systems that do not impose strict limitations on the size, type or packaging of items for shipment are also desired. Further, it may also be desirable to provide a system allowing for the pick-up and drop-off of items for shipment in rural or remote areas that may not be accessed by traditional shipping carriers. Further, users may also desire to pick-up and drop-off packages without any cut-off times and to utilize a shipping system with lead times as quick as a non-stop route between the origin and destination locations.

### SUMMARY

Aspects of the present disclosure relate generally to shipping systems and methods. Additionally, the present disclosure relates to one or more aspects intended to improve on prior shipping systems and methods, including, but not limited to the cost, efficiency, reliability, environmental impact and convenience of such systems and methods.

In some examples, a crowdsourced shipping solution that engages everyday commuters or travelers to transport items along their commute or routes they are taking anyway, providing a novel way for individuals and businesses to ship their packages is described. A crowdsourced methodology may mitigate the costs typically associated with same-day shipping services, while providing customers those added values that traditional services cannot provide. The system may leverage geotracking and activity prediction technologies to pair these commuters with those requesting just-in-time shipping (same-day shipping, deliveries), all in real-time. As more data is gathered from users, the system may be able to develop more advanced matching algorithms—in turn leading to more nuanced data, allowing the system to develop even more sophisticated matching algorithms.

Some embodiments of the present disclosure provide a method comprising: (1) receiving a shipping need from a customer via a customer remote device connected over a communications network to a server system, the shipping need including a destination; (2) receiving spatiotemporal information for each of a plurality of runners via a plurality of runner remote devices coupled over a communications network to the server system; (3) generating one or more travel routes for each of the plurality of runners based, at least in part, on the spatiotemporal information; (4) identifying one or more customer opportunities for the shipping need, each of the customer opportunities being identified based, at least in part, on an intersection of at least a portion of the one or more travel routes and the destination, within a predetermined spatiotemporal deviation; and (5) selecting one of the one or more customer opportunities for fulfilling the shipping need.

The term “intersection” as used herein is not to be understood to include only an exact overlap, intersection or identity in data points, locations, trajectories, travel paths, times, or preferences, etc. In general, the likelihood that the characteristics of a runner, his or her spatiotemporal information and/or his or her travel path and the preferences of a customer and the details of the shipping need will overlap exactly is very remote. Therefore, the term “intersection” is intended to be interpreted more broadly to include relative or inexact matches having some level of variation in the fit between the parameters being compared by the system. The level of acceptable variation may be set by customers and runners, or may be determined from perceived preferences of the customers and runners.

Depending on the nature of the shipping need, the customer may only identify a destination. In some cases, the customer may not know the point of origin of the item to be shipped at the time the shipping need is input into the system. For example, the customer may have ordered an item from a retail or internet-based store and needs the item delivered to his or her home address (the destination), but the exact origin of the good is unknown to the customer. In such cases, the origin may be determined by the customer at a later time or in some other manner, such as being provided directly by the seller of the good.

In other examples, the shipping need may also include an origin specified by the customer. In such cases, each of the customer opportunities may further be identified based, at least in part, on an intersection of least a portion of the one or more travel routes and one or both of the origin and the destination, within a predetermined spatiotemporal deviation. The shipping need may also include a desired time of delivery at the destination. In such cases, each of the customer opportunities may be identified based, at least in part, on an intersection of least a portion of the one or more travel routes and one or both of the destination and the desired time of delivery at the destination, within a predetermined spatiotemporal deviation.

Travel routes may further be generated, at least in part, based on geospatial information, including known roadways, waterways, railways, pedestrian routes, bike routes, and public transit routes, a runner's mode of transportation, traffic conditions, weather conditions and elevation changes. In other examples, the travel routes may be generated, at least in part, based on the runner's preference information, which may include the runner's preferred time of delivery at a shipping need destination, neighborhoods of origin, neighborhoods of destination, locations of origin, locations of destination, and cargo characteristics of a shipping need. The runner's preference information may be generated based, at least in part, on historical data relating to shipping needs fulfilled by the runner. In other examples, the runner's preference information may include the runner's historical consumer data, including genres of products or services purchased by the runner, franchises or stores at which a runner has purchased products or services, brands of products or services purchased by the runner, pricing of products or services purchased by the runner and times of day the runner purchased a product or service.

In still further examples, travel routes may be generated based, at least in part, on a combination of two or more of a runner's spatiotemporal information, a runner's preference information, and geospatial information. A runner's spatiotemporal information may include one or more of a time of day and the runner's appointments, schedule, known current location, predicted current location, known future location, historical location data, historical route data, approximate speed of travel and approximate direction of travel. A runner's spatiotemporal information may be received by one or more of: being input by a runner, being imported from an electronic calendar, being imported from a software application capable of obtaining spatiotemporal information of a runner, and being gathered from a location tracking or navigation device. A runner's historical location data may include locations previously visited by the runner, the number of times the locations were previously visited, and the days of the week and times of day the locations were previously visited.

Further, the travel routes may include an approximate start point and time, an approximate end point and time and one or more approximate intermediate points and times. Each of the customer opportunities may be identified based, at least in part, on an intersection of the destination and at least one of the approximate start point and time, approximate end point and time and one of the one or more approximate intermediate points and times of a travel route, within a predetermined spatiotemporal deviation.

In some cases, the one or more customer opportunities may automatically be selected for fulfilling the shipping need. Such selection may be made based on pre-set parameters or on preferences or parameters set by a customer to be applied to all shipping needs. In other cases, the customer may also be provided, via the customer remote device, with an indication of the customer opportunities. Subsequently, the customer may select, via the customer remote device, one of the one or more customer opportunities.

In other aspects, one or more runner opportunities may also be identified based, at least in part, on an intersection of at least a portion of the one or more travel routes of one of the plurality of runners and the destination, within a predetermined spatiotemporal deviation. An indication of the one or more runner opportunities may be provided to at least one of the plurality of runner remote devices and at least one of the plurality of runners may, via a runner remote device, select one of the one or more runner opportunities. The one or more runner opportunities selected by one of the plurality of runners may be identified as a runner endorsed opportunity and an indication thereof may be provided to the customer remote device. The customer may then select one of the runner endorsed opportunities via the customer remote device.

Shipping needs may also be received from a plurality of customers via a plurality of customer remote devices connected over a communication network to a server system, each of the shipping needs including an origin and a destination. The method may therefore further include: generating one or more shipping routes between the origin and the destination of each of the shipping needs; and identifying one or more customer opportunities for each of the shipping needs, each of the customer opportunities comprising one of the one or more travel routes that intersects one of the one or more shipping routes.

Some embodiments of the present disclosure provide a server system coupled to a communications network, the server system configured to: (1) receive from a customer remote device connected over the communications network to the server system, one or more shipping needs, the shipping needs including a destination; (2) receive from each of a plurality of runner remote devices connected over a communications network to the server system, spatiotemporal information for each of a plurality of runners; (3) generate one or more travel routes for each of the plurality of runners based, at least in part, on the spatiotemporal information; (4) identify one or more customer opportunities for each of the one or more shipping needs, each of the customer opportunities being based, at least in part, on an intersection of at least a portion of the one or more travel routes and the destination, within a predetermined spatiotemporal deviation; and (5) select one of the one or more customer opportunities for fulfilling the shipping need.

In further examples, the server may be configured to: provide to the customer remote device an indication of the one or more customer opportunities for each of the one or more shipping needs; and receive from the customer remote device a customer opportunity selected from the one or more customer opportunities.

In still further examples, the server may be configured to: identify one or more runner opportunities for each of the plurality of runners, each of the runner opportunities being based, at least in part, on an intersection of at least a portion of the travel routes of each of the plurality of runners and the destination, within a predetermined spatiotemporal deviation; provide to the plurality of runner remote devices an indication of the one or more runner opportunities for each of the plurality of runners; and receive from the plurality of remote devices a runner opportunity selected from the one or more runner opportunities for each of the plurality of runners. Runner endorsed opportunities may be identified based on the one or more runner opportunities selected by the plurality of runners. An indication of the one or more runner endorsed opportunities for each of the one or more shipping needs may be provided to the customer remote device and a customer opportunity may be selected from the one or more runner endorsed opportunities.

The system may further be configured to receive shipping needs from a plurality of customers via a plurality of customer remote devices connected over the communications network to the server system, each of the shipping needs including an origin and a destination; generate one or more shipping routes between the origin and the destination of each of the shipping needs; and identify one or more customer opportunities for each of the shipping needs, each of the customer opportunities comprising one of the one or more travel routes that intersects one of the one or more shipping routes.

Some embodiments of the present disclosure provide a method comprising: (1) receiving a shipping need from a customer via a customer remote device connected over a communication network to a server system, the shipping need including a destination; (2) receiving, via a plurality of runner remote devices coupled over a communication network to the server system, at least one approximate current location and at least one approximate future location for each of a plurality of runners; (3) identifying one or more intersections between at least one of a shipping need destination, a runner current location and a runner future location; and (4) identifying a customer opportunity for each of the one or more shipping needs based, at least in part, on the one or more intersections. An intersection may occur when a shipping need destination falls within a predetermined deviation in travel time or geographical distance from either or both of a runner approximate current location and a runner approximate future location.

One or more travel routes may be generated for each of a plurality of runners. The travel routes may be generated based, at least in part, on the at least one approximate current location and at least one approximate future location of each of the plurality of runners. One or more intersections of at least a portion of the one or more travel routes and the destination may be identified. The method may further include identifying a customer opportunity for each of the one or more shipping needs based, at least in part, on the one or more intersections. An intersection occurs when the destination falls within a predetermined deviation in travel time or geographical distance from one of the one or more runner travel routes.

The aforementioned methods and systems may be implemented by or as a computer having a processor and a memory. The computer may be a personal computer, a mobile phone, a smart phone, a tablet or any other handheld, wearable or cloud computing device.

The above and additional aspects, examples, and embodiments are further described in the present disclosure.

### BRIEF DESCRIPTION OF THE DRAWINGS

FIG. 1 is a block diagram illustrating an exemplary system.

FIG. 2 is a flow diagram illustrating an exemplary method.

FIG. 3 is a flow diagram illustrating an exemplary method.

FIGS. 4-8 are screenshots illustrating an interface of an exemplary system.

### DETAILED DESCRIPTION

The following detailed description sets forth various features, functions, and attributes with reference to the accompanying figures. In the figures, similar symbols typically identify similar components, unless context dictates otherwise. The illustrative embodiments described herein are not meant to be limiting. Certain features, functions, and attributes disclosed herein can be arranged and combined in a variety of different configurations, all of which are contemplated in the present disclosure.

Generally, embodiments described herein are directed to systems and methods for crowd-sourced shipping. The term “shipping” should be understood in its broadest sense and includes all forms of delivery, transporting, conveying, and transferring items between an origin and a destination.

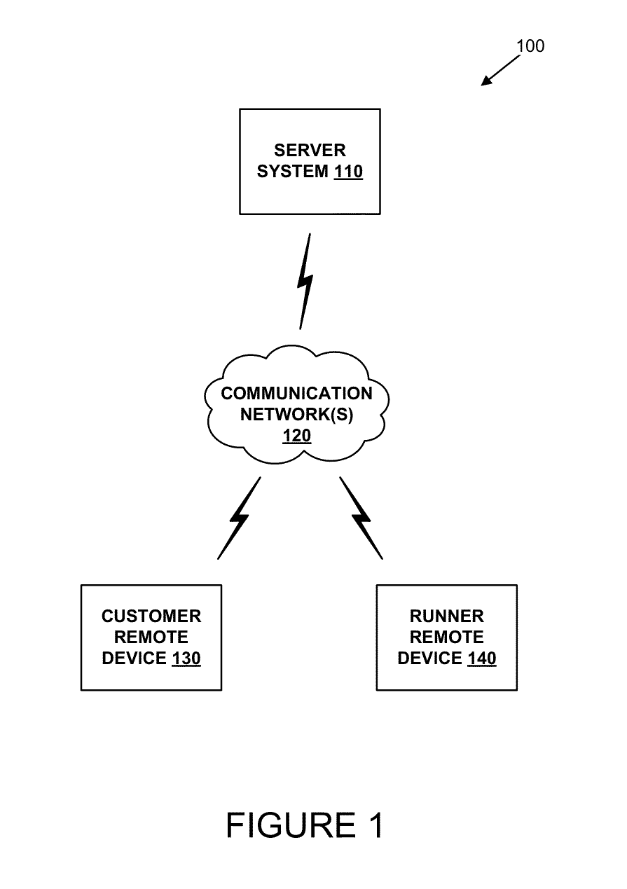

FIG. 1 is a block diagram illustrating an example system 100. The system 100 may be implemented as a server system 110 coupled to a communication network 120. Other implementations, such as a cloud computing system, are also contemplated. The server system 110 may be configured to receive inputs from one or more customer remote devices 130 and one or more runner remote devices 140. The remote devices may include any type of remote computing device, such as a mobile or cellular telephone, a tablet or desktop computer, operating a mobile or web-based application.

As will be described in more detail below, the shipping system 100 may be configured to receive from the one or more customer remote devices 130 connected over the communication network 120 to the server system 110, one or more shipping needs. The shipping needs may include a number a different parameters or characteristics, such as a destination. The system 100 may further be configured to receive from each of a plurality of runner remote devices 140 connected over the communication network 120 to the server system 110, information for each of a plurality of runners. Such information may include, among other things, spatiotemporal information. The server system 110 may then generate one or more travel routes for each of the plurality of runners based, at least in part, on the runner information, which may include spatiotemporal information. One or more customer opportunities may then be identified by the server system 110 for each of the one or more shipping needs. Each of the customer opportunities may be based, at least in part, on an intersection of at least a portion of the one or more travel routes and the destination, within a predetermined spatiotemporal deviation. The server system 110 may be configured to select one of the one or more customer opportunities for fulfilling the shipping need. The system may further be configured to receive, retrieve or generate information, such as spatiotemporal information, geospatial information and preference information.

In some examples, at least one “customer”—an individual or entity that has a shipping need—and at least one “runner”—an individual willing to transport a good along his or her commute or travel route—may utilize an embodiment of the system. A shipping need may include any need to have an item shipped, transported, delivered, couriered, etc., from a point of origin to a point of destination. The shipping need may include, for example, a need to have an item picked up from a third party and delivered to the customer, a need to have an item picked up from a customer and delivered to a third party, or a need by a customer to have an item picked up from a first third party and delivered to a second third party. Shipping needs each generally require an input action by the customer; however, a recurring need may be either scheduled by a customer, or may be recognized by the system if a pattern is established.

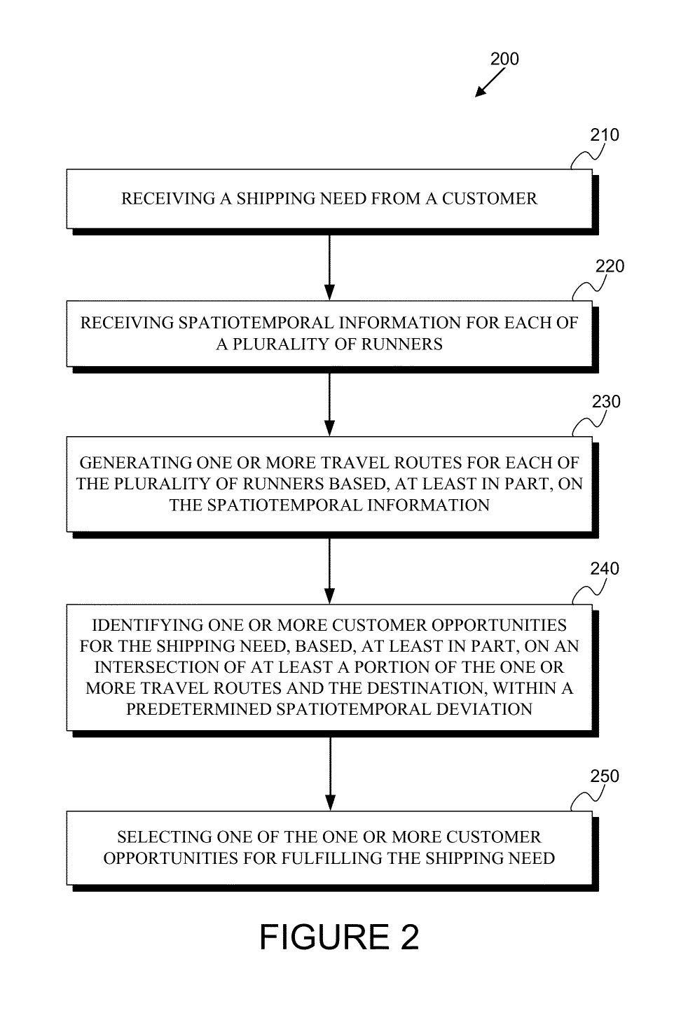

FIG. 2 is a flow chart of an exemplary method 200 for processing a shipping need. In a first step, a shipping need is received from a customer (210). The customer may input various characteristics of the shipping need, which may include, among other things, a destination, an origin, a desired time of delivery at the destination, a desired time of pickup at the origin, or a combination of one or more of these. The shipping need may be received via a customer remote device connected over a communication network to a server system, or other remote computing system. Information may also be received for each of a plurality of runners (220), in some cases, via a plurality of runner remote devices coupled over a communication network to the server system. This information may include spatiotemporal information, preference information and geospatial information. In a next step, one or more travel routes are generated for each of the plurality of runners based, at least in part, on the spatiotemporal information (230). One or more customer opportunities are then identified for the shipping need (240). The identification of the customer opportunities may be based, at least in part, on an intersection of at least a portion of the one or more travel routes and the parameter(s) received regarding the shipping need, such as the destination, within a predetermined spatiotemporal deviation. One or more of the customer opportunities are selected for fulfilling the shipping need (250).

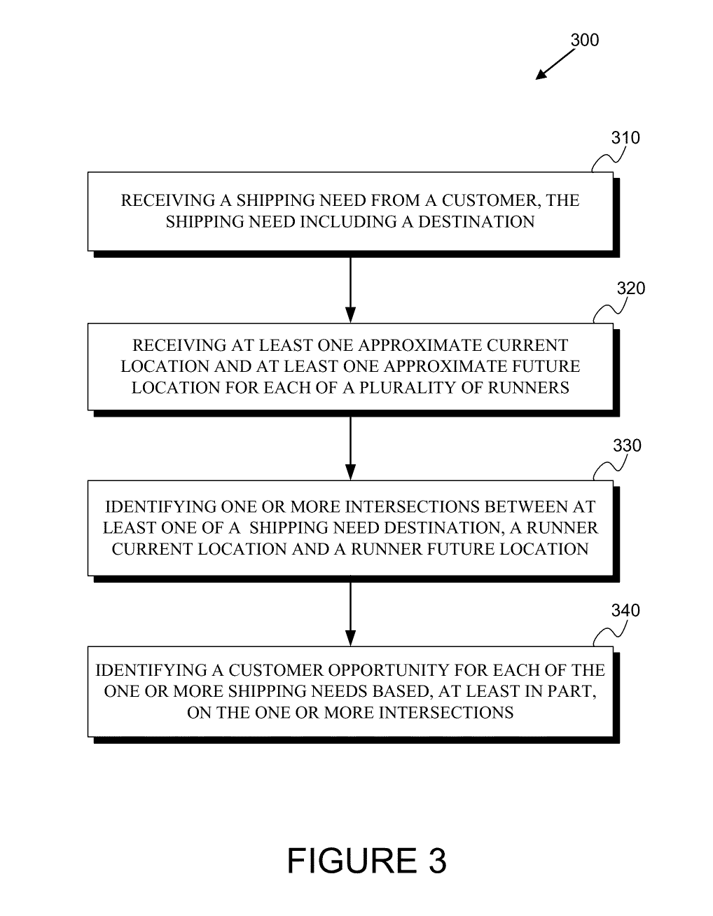

FIG. 3 is a flow chart illustrating another embodiment of a method 300 for processing a shipping need. In a first step, a shipping need is receiving from a customer via a customer remote device connected over a communication network to a server system (310). The shipping need includes a destination. In a next step, at least one approximate current location and at least one approximate future location for each of a plurality of runners is received via a plurality of runner remote devices coupled over a communications network to the server system (320). One or more intersections between at least one of a shipping need destination, a runner current location and a runner future location are then identified (330). In a next step, a customer opportunity for each of the one or more shipping needs is identified based, at least in part, on the one or more intersections.

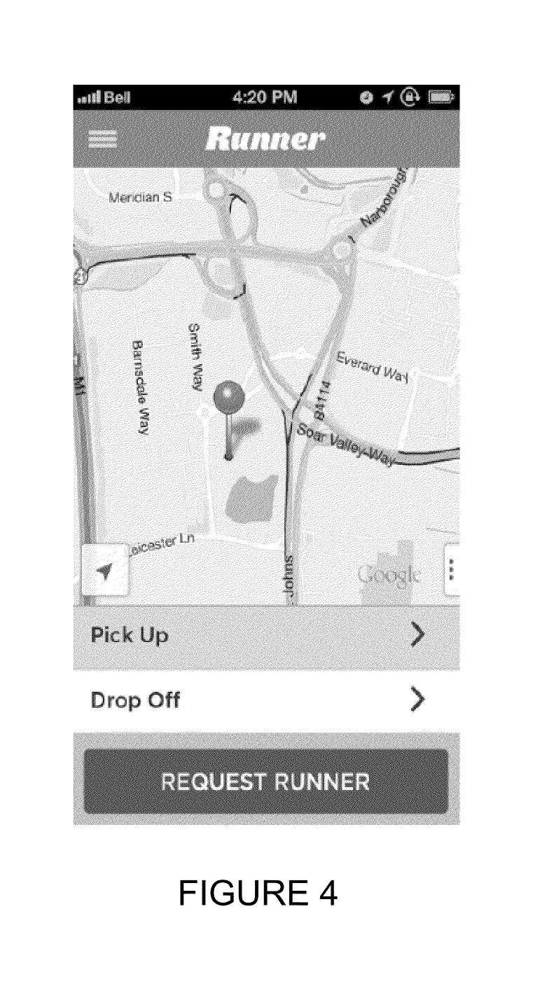

The features of the above-mentioned system and method will now be described in further detail. In operation, a customer may submit a shipping need to the system, which may be implemented with a website or mobile application. FIGS. 4-8 illustrate screenshots of several interfaces of an exemplary system implemented as a mobile application. The customer may indicate certain parameters relating to the shipping need, including an origin location, a destination, the associated time frame and a maximum price that he/she is willing to pay for the job. (See FIG. 4, which illustrates a screenshot of an interface from an exemplary mobile application where a user may input shipping need parameters including pick-up and drop-off locations). As discussed above, in some examples, the customer may only input a destination for the item to be shipped, for example, if the origin is unknown or is to be input at a later time or by a third party. A customer may also input certain preferences into the system, including preferred runner characteristics, such as age, race, sex, mode of transportation (e.g., car, bike, public transportation, walking) and neighborhood of residence.

Runners who are willing to transport items along their commute may choose to participate in the system. A participating runner may create a profile or avatar within the system and may input certain information into the system including personal information, such as age, race, gender, etc., appointments and other scheduling information (workday start and end times, medical/dental appointments, personal training appointments or gym classes, business meetings, lunch or dinner appointments, etc.), addresses (e.g., home, work, gym, preferred grocery store, daycare, etc.), modes of transportation (e.g., car, bike, public transportation, walking), etc. In addition, a runner may choose to allow the system to access a runner's electronic calendar(s), devices, applications, etc. from which the system may gather additional spatiotemporal information about the runner.

The system will generate one or more pathways or travel routes for each of the participating runners. These travel routes may include those that the system knows the runner will take and routes that the system predicts that the runner might take. Notably, the system may include algorithms for learning the schedule, habits, and preferences of a runner. Other data relevant to predicting a runner's travel route may also be learned or received by the system. A runner may choose to allow the system to gather information and data from devices or applications that may track or disclose a runner's location, historical locations, or a historical pattern of locations (GPS or other positioning devices, mobile or cellular devices, Yelp, Facebook, OpenTable, FourSquare, Mapmyfitness, etc.), devices or applications that may track a runner's internet searches or mapping/direction requests, or applications or services that track a runner's purchases (such as credit cards, store bonus cards).

Travel routes may be generated based on one or a combination of a runner's spatiotemporal information, a runner's preference information, and geospatial information. Geospatial information may include information relevant to known ways and routes that people and vehicles travel in a given location, including known roadways, waterways, railways, pedestrian routes, bike routes, and public transit routes, and a runner's mode of transportation, as well as conditions that may affect that travel, including traffic conditions, weather conditions and elevation changes. The generated travel routes may also include an approximate start point and time, an approximate end point and time and one or more approximate intermediate points and times.

A runner's preference information may include a runner's preferred times for making deliveries, neighborhoods of origin, neighborhoods of destination, locations of origin, locations of destination, and cargo characteristics of a shipping need. Preference information may also include a runner's historical consumer data, including genres of products or services purchased by the runner, franchises or stores at which a runner has purchased products or services, brands of products or services purchased by the runner, pricing of products or services purchased by the runner and times of day the runner purchased a product or service. This information may be used to predict a runner's future travel routes, or to predict which opportunities may be most desirable to a runner.

Such preference information may be manually input by a runner and/or may be generated or learned based, at least in part, on data gathered by the system regarding the shipping needs the runner has historically chosen to accept and fulfill, consumer and purchasing data gathered by the system and a runner's habits.

A runner's preference information may also include preferences based on direct or tangential relationships. For example, a runner's historical consumer data may indicate that the runner frequently visits and makes purchases at coffee shops. The system may therefore predict that the runner may have a preference for accepting an opportunity if the opportunity involves picking something up at a coffee shop or next to a coffee shop, or if a coffee shop lies along the route, even if the runner has never been to that particular coffee shop. In another example, the system may learn that the runner has a preference for a specific brand of coffee or coffee shop, i.e. Starbucks. Based on this preference information, the system may predict that the runner may prefer to accept opportunities where that brand of coffee shop lies along the route, even if the runner has never been to that particular location. The same types of preference inferences may be drawn not just between associated locations, or types of locations, but associated times, neighborhoods, types of cargo that a runner prefers to accept, etc. Thus, preference information may include not only the raw data, but also the relational or tangential data inferred from or associated with the actual data points.

A runner's spatiotemporal information, which also may be used to generate travel routes, may include one or more of a time of day and the runner's appointments, schedule, known current location, predicted current location, known future location, historical location data, historical route data, approximate speed of travel and approximate direction of travel. Historical location data may include locations previously visited by the runner, the number of times the locations were previously visited, and the days of the week and times of day the locations were previously visited. A runner's spatiotemporal information may be directly input into the system by a runner, may be imported from an electronic calendar or a software application capable of obtaining spatiotemporal information of one of the plurality of runners, gathered from a location tracking or navigation system (such as GPS, INS, NAVSAT, Galileo, GLONASS, BeiDou, COMPASS, IRNSS, QZSS, etc.) on or accessible by one of the plurality of runner remote devices, gathered from devices or applications that may track or disclose a runner's location, historical locations, or a historical pattern of locations (GPS or other positioning devices, mobile or cellular devices, Yelp, Facebook, OpenTable, FourSquare, Mapmyfitness, etc.), or gathered from devices or applications that may track a runner's internet searches or mapping/direction requests, or applications or services that track a runner's purchases (such as credit cards, store bonus cards). Other spatiotemporal data relevant to predicting a runner's travel route may also be learned or received by the system.

Based on one or more of these types of information, the system may generate one or more travel routes for each runner. At any given point in time or space, there are potentially infinite pathways for a runner. That is, with all of the information received for each runner—geospatial information relevant to the runner's location, a runner's preferences and a runner's spatiotemporal information—there are a large number of potential or projected travel routes that the runner may take at any given point in time. Further, the system may continuously (or at certain times) update a runner's travel routes based on new or changed information (the time of day, a change in the runner's position or schedule, etc.). As more data points are collected and more information is learned about a runner, particularly with respect to his or her schedule and habits, patterns and preferences will begin to appear and the system's predictive capabilities may improve.

The information gathered from and about a runner may then be compared to one or more customer shipping needs that have been received by the system. An “opportunity” arises when one or more of the runner characteristics matches/intersects/overlaps, to a certain degree, with one or more characteristics of the customer need. This matching or comparison process raises several issues addressed by embodiments disclosed herein: (1) How or what aspects of the runner characteristics and the shipping need characteristics are compared to determine if an opportunity arises?; (2) how closely must the runner characteristics and shipping need characteristics match for a customer opportunity to be identified?; and (3) what opportunities will be presented to runners and customers for consideration?

In one example, a customer opportunity arises when a shipping need “intersects” one or more of the runners' travel routes. The system may compare the generated travel routes to the shipping needs that have been input into the system by customers to identify one or more customer opportunities. Generally, the system will compare the generated travel routes with the customer opportunities to determine if one or more parameters (time, location, customer preferences, etc.) of the shipping need match, to some degree, with the travel routes. In examples where the shipping need includes only destination information, the customer opportunity may be identified based, at least in part, on an intersection of a portion of a travel route with the destination, within a certain spatiotemporal deviation. If the shipping need also includes a point of origin, then a customer opportunity may be identified based, at least in part, on an intersection of at least a portion a runner's travel route and one or both of the origin and destination, within a spatiotemporal deviation. The shipping need may also include additional parameters, such as a desired time of delivery at the destination and a desired time of pickup at the origin. Accordingly, a customer opportunity may be identified based, at least in part, on an intersection of at least a portion of the one or more travel routes and one or both of the destination and the desired time of delivery at the destination, within a predetermined spatiotemporal deviation. Additionally or alternatively, a customer opportunity may be identified based, at least in part, on an intersection of at least a portion of the one or more travel routes and one or both of the origin and the desired time of pickup at the origin, within a predetermined spatiotemporal deviation.

In other examples, instead of generating travel routes for each of the runners and comparing those routes to the shipping needs, the system may identify customer opportunities based on an intersection between the shipping need and one or more runner characteristics, such as a runner's current location or a runner's future location, which may include known and predicted future locations. An intersection may occur when a shipping need destination falls within a predetermined deviation in travel time or geographical distance from either or both of a runner approximate current location and a runner approximate future location. Customer opportunities may also be identified based, at least in part, on an intersection of at least one parameter of the shipping need and at least one of the approximate start point and time, approximate end point and time and one of the one or more approximate intermediate points and times of a travel route, within a predetermined spatiotemporal deviation.

Exact matches or intersections in the characteristics of the shipping need and a travel route will likely be rare. Therefore, the system may be designed to identify customer opportunities that are “relatively” good intersections or intersections that facially seem imperfect, but would, in fact, be “acceptable” to the parties. That is, the system may identify customer opportunities when a deviation “around” a shipping need and a deviation “around” a runner's travel route intersect. The amount of deviation may be a preset default set by the system, may be manually set by a party and/or may be learned from a party's habits and preferences (e.g., historical choices made within the system, historical consumer data, etc.). Not only might a customer be willing to modify the parameters of the shipping need to a certain degree, for example, to accept a later delivery time or slightly different origin location, but a runner may be willing to deviate from his or her usual pattern or travel route to a certain degree. More details about this matching function are provided below.

Once the system has identified one or more customer opportunities, the job may be confirmed and progressed to fulfillment in a number of ways. The system may be configured to automatically select the customer opportunity that represents the best match or intersection of the shipping need with a travel route for fulfilling a shipping need. In some cases, the “best” opportunity may be the one with the most matching data points between the travel route and shipping need, or it may be the opportunity that the system determines would be the most acceptable to both parties. These two measures may not always result in the same opportunity selection.

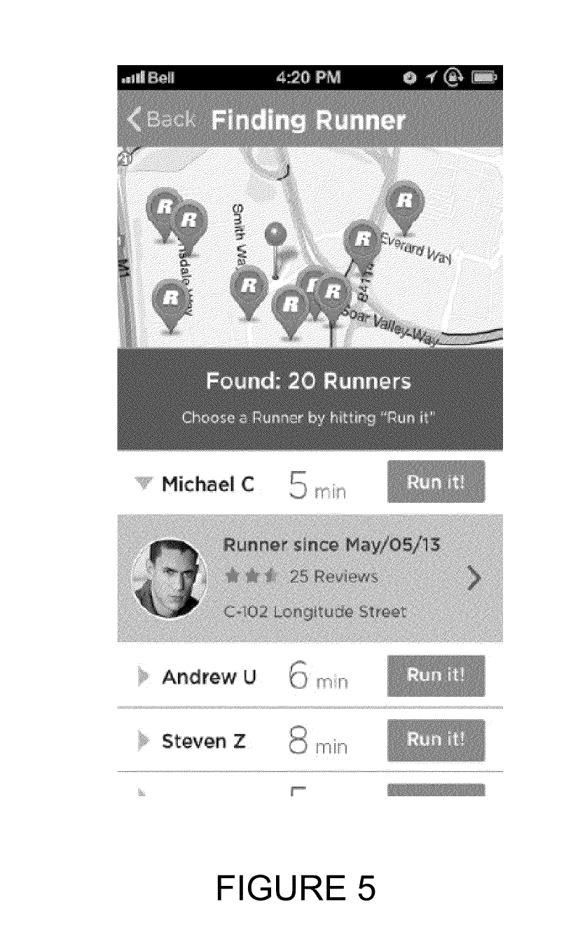

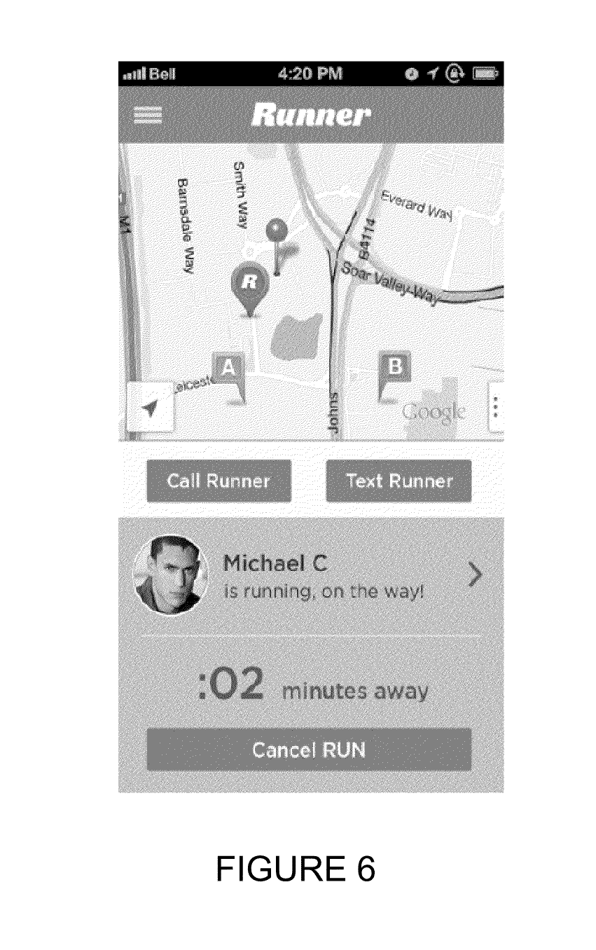

In other examples, the customers may be provided with an indication, such as a list, graphical representation, etc., of the customer opportunities from which the customer may make a selection. (See, e.g., FIGS. 5 and 6, illustrating a screenshot from an exemplary mobile application, displaying customer opportunities on a map indicating the location of each of the respective runners and confirmation of a selection of a runner). Customers may be presented with multiple customer opportunities, if their shipping needs have intersected more than one travel route (not just multiple routes of a single runner but also routes of multiple runners). Once a customer has selected a customer opportunity, the associated runner may receive a notification of the customer's selection and may agree to fulfill the shipping need. Alternatively, the runner may decline the job, or may suggest modifications of the shipping need to the customer, for example, “if the drop-off time can be 20 minutes later, then I will accept the job.”

In some cases, it may be desirable to not provide the customer with an indication of all of the identified customer opportunities, which may include intersections between the shipping need and the numerous predicted runner travel routes for each of the participating runners that have been generated by the system. For example, it may be beneficial to filter the universe of customer opportunities by those opportunities that one or more runners have “endorsed” or indicated they would actually fulfill. To this end, the system may be configured to identify one or more runner opportunities based on an intersection of at least a portion of a runner's travel route(s) and at least one characteristic of a shipping need (e.g., destination, origin, time of delivery, time of pick-up, etc.). Multiple runner opportunities may be identified for each runner if that runner's travel route(s) have intersected one or more shipping needs. A runner may be provided with an indication (e.g., a list, graphical or spatial representation) of the one or more runner opportunities and may select one or more runner opportunities therefrom that he or she would be willing and able to fulfill. The customer may be provided with an indication of the runner endorsed opportunities, or runner opportunities that have been selected by one or more runners, and may make a selection therefrom.

Example systems and methods may include or employ matching algorithms to identify customer and/or runner opportunities based on, at least in part, at least one characteristic of a shipping need (i.e., origin, destination, time of pick-up, time of delivery, etc.) and at least a portion of one or more travel routes generated for a runner, a runner's current location or a runner's future location(s). These algorithms may include or employ predictive analytics, geo-tracking, activity recognition, or behavioral forecasting, for example. As described above, the algorithms may initially rely heavily on information manually input into the system by customers and runners. However, as time goes on and the system is used more, the parties will input more information and/or the system will gather more data about the parties themselves, participants of like-market-segments, and the community of participants at large, that will enable it to learn and predict the habits and preferences of the customers and runners. These new data points will enable even more sophisticated algorithms for even more accurate matching, which will in turn allow the system to collect and analyze even more specific data, for more accurate matching, so on and so forth in an ever advancing cycle.

The algorithms used by or in the example systems and methods may build beyond just spatiotemporal matching, and may cross-reference other factors, or combinations of factors, that optimize matching between the parties. These factors could include but are not limited to optimizing preferences relating to gender; race; age; ethnicity; language; education level; socioeconomic status; location (some people might not want to pick up or drop off packages in certain neighborhoods); requested versus accepted fees, timing, consumer preferences, etc. The factors could also include various behaviors or practices of a runner or customer. The system may be configured to learn a customer or runner's preferences and behaviors based on a history of customer opportunities selected (or rejected) by the parties. From these learned preferences, the system may predict the likelihood of a customer and/or runner accepting a certain opportunity and, based on this likelihood, determine whether a particular opportunity should be presented to a runner and/or customer.

Predicting the likelihood that a runner or customer will accept a particular opportunity can be based, not only on a particular runner or customer's individual preferences and behaviors, but also the preferences and behaviors of other classifications of individuals. In some aspects, the system may use these personal, demographical, and behavioral arrays of information to classify individuals on these bases and predict the likelihood that a runner or customer will accept an opportunity. For example, the system may, over time, learn the preferences and behaviors of like-market-segments or demographics of customers and runners and use those learned preferences and behaviors to predict how a runner or customer falling within a demographic would respond to an opportunity having certain characteristics. The system may classify preferences and behaviors on a range of levels, from the individual to the community at large, and compare a particular runner or customer to these various classifications for predictive purposes. Some such classifications may be based on specific demographics, for example, and others may be a coordinate representation encompassing a precise calibration of many factors that designate a “type” of person.

Further, as time goes on, the definition or parameters of an “appropriate” opportunity or an “acceptable” deviation from the exact parameters set for a shipping need or of a runner's travel route(s) can be largely determined by behavioral data to find the “preferences” of the customers and runners. In one aspect, the system may present opportunities to runners and customers, based on the patterns discovered from their prior choices and responses. Gathering more data points regarding the parties' positive and negative responses, allows the system to present opportunities that are more desirable to both customers and runners, refining those algorithms over time.

For example, in one instance, a straight-line route for cargo to be brought from an origin location to a destination location may be deemed acceptable to both runner and customer. Perhaps, however, a slightly more “off-course” route would be generally unacceptable to either runner or customer. In such cases, the perceived variation in the two routes may be more relevant to understanding what is acceptable or unacceptable, than the actual variations in distance, time and path. It may seem to the runner and/or customer that a straight-line opportunity using streets alone would be more efficient than a seemingly “off-course” detour to the freeway, even though the freeway route would save net time. Regardless of the fact that the freeway route is more efficient, the system may identify that the more efficient pathways are usually rejected by the parties and would therefore learn to edit or filter the presented opportunities accordingly.

The system may also be configured to identify other differences between generated runner travel routes and shipping need parameters that render an opportunity less desirable to the runner or customer. For example, suppose that the system generates two travel routes A and B that are very similar, both consisting of relatively straight paths including both the cargo origin and destination, and differing only in that a small partition, such as a waterway or a freeway, intersects route A. Based on party responses, the system may determine that the opportunity including route A is generally less acceptable to either or both parties. Other differences, such as time of day, can also affect the acceptability of an opportunity. Perhaps rush-hour traffic or predicted bad weather at the time of that particular opportunity may make it undesirable. Recognizing these preferences based on runner and customer responses will aid the algorithms over time in recommending the most desirable opportunities. The system may learn from the parties' responses over time. Moreover, the system may utilize both individual and collective data. Over time, the system may not only learn to identify individual runner and customer preferences, but it may also learn from the overall community of runners and customers as well.

The system may also be configured to account for pricing in its “acceptability” algorithms. In many cases, the lower the price, the more likely a customer is to find that opportunity acceptable. However, this may not always hold true. For example, an opportunity comprising a straight-line route between the origin and destination may be found to be generally accepted for a price of $10, yet generally rejected for $9. From this data, the system may learn that a $1 difference is a very large determinant of acceptability for this specific opportunity and may weigh this information accordingly in determining which opportunities to present in the future. The system may also use this data in configuring a “suggested price” for users.

The definition of an “acceptable” opportunity may be determined by many factors. In fact, the users themselves may not be entirely conscious of all the factors determining their own decisions. With diverse and sufficiently large amounts of data, the system may effectively automate one or more aspects of the cycle that includes data gathering, processing data, analyzing data, and implementing more accurate algorithms. These dimensions could be based on socio-economic data, education, shopping habits, gender, race, job function, industry, personality qualities, upbringing, etc.

Another consideration is the level of spatiotemporal specificity of the matching algorithm. The system must know how wide of a net to cast when it scans a runner's travel routes against customer shipping needs, i.e. within a radius of a mile, two miles, half a mile, etc. If the radius is set to half a mile, it may be undesirable to exclude opportunities that would be acceptable to both a runner and a customer even if the travel route strays outside of the half-mile radius for only one brief point. At the same time, however, it may be undesirable for the system to be so “broad-stroked” in its spatial scans that it recommends opportunities that are undesirable to either the runner or customer or both. Such a parameter may be preset by the system, it may be input by the runners or customers, or it may be generated by the system based on perceived preferences. Moreover, the smaller the units of measure, the more accurate the system's sensory readings of customer and runner behavior can be and, thus, the more useful these readings will be in the system's subsequent data analysis and usage to create more accurate recommendations in the future.

Similarly, the “temporal” radius of the scan may also be considered. Should the system recommend opportunities in which the runner's planned timing for the travel route is 10 minutes before or after the shipping need's time frame? 20 minutes? 5 minutes? Again, it may be undesirable to exclude opportunities in which the timing at one point is just outside of range, but otherwise perfectly acceptable by the two parties. It may also be undesirable for the system to be too wide with the time “radius” because it may make recommendations that are beyond reasonable consideration by the parties. Likewise, beyond just the “scanning” consideration, the sensory data gathered from more closely related temporal matches may allow the system to generate more useful and accurate data and analyze and use that data to create more accurate opportunity recommendations in the future.

Further, the system may consider a distribution in the acceptable variations along the routes. Thus, the system may consider more than just net difference in distance or time, but the perception of acceptable difference in distance and time. Data reactant to customer behavioral patterns may be used by the system as well. For example, it may be unlikely that a runner would accept an opportunity that deviates more than X percent/distance/time from his or her intended travel route. However, it may also be true that X deviation is acceptable to a runner if only approximately 50% of that deviation is confined to the first segment of the route. While this may not necessarily be rational from a measurable understanding of the customer behavior, it may be the case nonetheless and it may be important for the system to learn this behavior.

One value of presenting more accurate acceptable opportunities for both runner and customer is the “real-time” advantage. The most ideal opportunity for a given customer need comprises an ideal route at an ideal time with an ideal transaction party, and at a minimum acceptable price.

The disclosed system and method may also provide certain benefits and include features that traditional shippers and carriers typically do not or are unable to offer. For example, because the disclosed system and method rely, at least in part, on the preferences and willingness of the participating runners, the system may provide low-cost same-day shipping and potentially may be offered at any location in the world at any time of day. Typically, traditional carriers have strict timing and pricing parameters that may be prohibitively expensive or inconvenient or otherwise do not suit the needs of customers.

In addition, the system and method may provide for GPS tracking (or other location tracking method) of shipping jobs and check-ins by a runner in real time. (See, e.g. FIG. 6, illustrating a screenshot from an exemplary mobile application indicating the estimated time of arrival of a runner). Most shipping firms offer online package tracking, in a rare and infrequent way. Many only offer updates during a few key checkpoints, sometimes as much as days apart. Since mobile GPS tracking may be integrated into the present system, not only can customers actually request check-ins from the runners fulfilling their jobs, but runners can even offer continuous live tracking of their own location so that customers would always know the exact geographical coordinates, exact distance, and exact estimated time of arrival of their packages, all in real-time. The system may enable customers to track where runners are physically located, on time of arrival, distance to arrival, nearness to other points, and other checkpoints.

Additionally, the presently disclosed systems and methods may provide a level of security and psychological value to those who utilize the system. In one aspect, the system removes the “arms-length” transaction associated with most traditional carriers. By directly linking customers directly to a person (or persons) that will be carrying their package, the process collapses into a very secure and personal arrangement. Customers can add/edit/read runner reviews and ratings within the system. In another aspect, runners may work to build a reputation of trust and accountability, through star ratings and customer reviews. Much like building a trustworthy eBay profile, runners might be well advised to accept smaller jobs for lower prices in the very beginning Over time, a runner's reputation may afford him or her greater trust by customers, allowing them to accept bigger jobs, for higher pay. Further, runners can add additional details about themselves to build trust, such as address and contact information, places of employment, and connecting their other social media outlets, such as their LinkedIn and Facebook pages, to their runner account. Compare this to traditional shippers, in which such accountability is defaulted to the brand, or freight shipping networks, which are often virtually anonymous altogether. Customers can feel satisfied knowing exactly who is delivering their package and what they have to show for themselves, and having the power to choose a runner that they like.

This trade-off may alleviate security concerns, and create a balanced internal economy within the runner eco-system. That is, customers need not worry that the system itself is necessarily any less reliable than traditional shippers, but that reliability all depends on the specific runner. In some cases a customer will only take the most reputable and cross-verifiable runners, in others a customer's needs for the job may be so difficult, or their budget may be so low that they would need to be flexible with their selection criteria. Thus, in terms of psychological value, in some cases customers may consider an individual runner to seem even more reliable than a traditional shipping firm, due to that runner's established credibility and reputation. In other cases, a customer may feel less confident in a runner in that regard, yet that compromise would trade-off an added benefit of cost and/or opportunity value.

The system may also require runners to submit to a background check and identity verification, which would allow runners to demonstrate their credibility even more. For example, if they are verified, a badge will indicate that on their profile, for customer reference. The system may also provide runners with the option to delay adding a background check verification, so to not deter point-of-sale conversion. This would avoid having potential runners delaying the application process because the feel that they would be spending too much time applying to be a runner.

According to one embodiment, a customer can choose to pay runners electronically in one of three ways: (1) pay the runner upon accepting their offer (generally only a very reputable runner could request this), (2) pay the runner at the point of pick-up, or (3) pay the runner at the point of delivery. If the customer chooses to pay the runner after the package is delivered, there could be three sub-options as well: (a) allow the funds to be transferred automatically after the runner's GPS (or other location tracking) enabled device confirms arrival, (b) allow the funds to be transferred after the runner confirms delivery, (c) or allow the funds to be transferred after both runner and customer confirm delivery. If the customer chooses to only pay the runner after he or she too has confirmed that the package has successfully reached its destination, successful delivery can be confirmed in multiple ways as well.

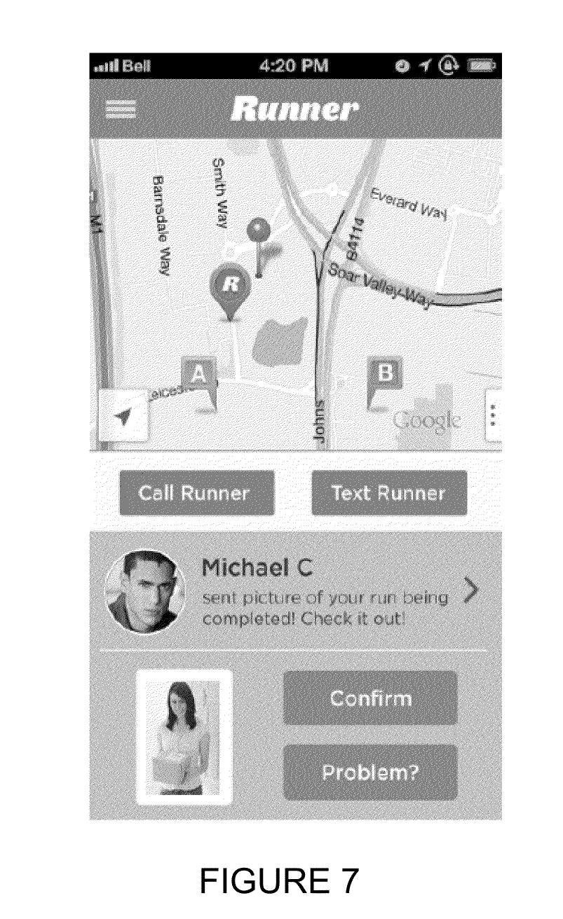

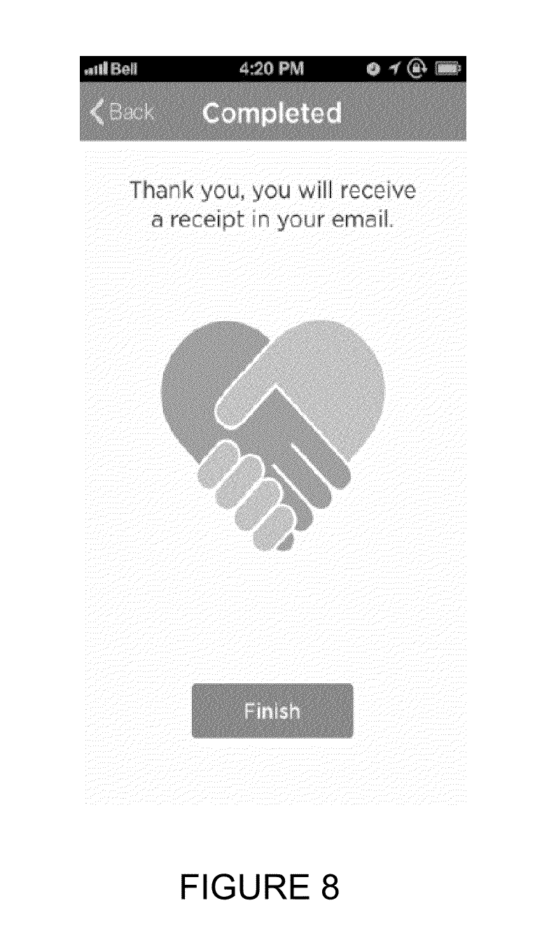

Various delivery confirmation and/or verification features may also be provided. In some examples, the system and method may include a photo verification feature. The runner may send, through the system, a picture taken at the point of pick-up or arrival at the drop-off, perhaps including themselves, the recipient, and the package or any other image requested by a customer, that a customer has indicated will satisfy him or her that the job has been fully completed to their level of satisfaction. (See, e.g., FIGS. 7-8, which are screenshots from an exemplary system implemented as a mobile application allowing a customer to confirm delivery, view a photo submitted by a runner indicating completion of a run, and a confirmation of transaction completion). Such an option may not only be used for runners to gain a good rapport in the system, but also to shield a runner and the system operator from claims that a package was damaged or not delivered.

In further examples, a quick response (“QR”) code may be sent to a customer upon scheduling a job for identity verification purposes. The customer may transfer or forward the QR code to another person (i.e., a friend, secretary, doorman, etc.) that he/she has designated as the intended recipient of the package. The runner who accepts the job can, at the point of delivery, scan the QR code to confirm both that the person receiving the package is the intended recipient, and that the job has been completed. This verification step may be necessary, in some embodiments, before payment is made to the runner, which may, in some cases, be an automatic funds transfer. Other identity verification methods are also contemplated.

Additionally, a verbal confirmation feature may be included in the disclosed systems and methods. In some examples, the customer can simply verify through a phone call or text that the package has been received, and then confirm delivery in the system, allowing the funds to be released to the runner. (See, e.g. FIGS. 6 and 7 illustrating “Call Runner” and “Text Runner” features in an exemplary mobile application). These solutions may provide an added level of assurance to customers, especially new ones.

In some examples, the system may include an internal payment processing system or payment processing may be outsourced to a trusted third party. Some payment processors offer buyer protection for lost or stolen goods as well. Despite these diverse security measures, disputes in online transactions can occur from time to time, and these measures will provide a basis for settling those disputes. Thus, runners will feel an added incentive for providing tangible confirmations, and customers would have added assurance knowing that without those confirmations, they would have the upper hand in a dispute.

In further examples, the disclosed systems and methods may include a “relay” option that may employ one or more networks of runners to fulfill a shipping need. Sometimes a customer's shipping need cannot reasonably be handled by a single runner. This could be because the either the pick-up point, the destination, or both are in infrequently accessed geographies, or that the distance is long enough that a single runner would rarely make that trip, or maybe even that a runner would be willing to make the trip under the customer's specified timeframe for which no traditional shipping option would, but the runner's asking price is far too high for that customer. In any or all of such cases, the system may provide a “relay” option for the customer's requested job. This process may work in much the same way as any other transaction in the system, except that an initial runner may pass the package off to one or more intermediate runners to get the package to its final destination. In some examples, all parties would need to agree to the relay and several aspects thereof. For example, the customer and the runner(s), at the most basic level, would agree to submit to a relay job and the customer would be required to accept all of the runners who have agreed to participate. Additionally, all of the runners presented with the relay job would be required to accept all of the other runners presented with the job. Runners would have to make a similar determination in regard to the status of the runners with whom they will be working (risk vs. reward). The runner(s) and customers would need to agree on the amount and mode of payment, according to this example.

The system may also include a contingency option for unfulfilled relay transactions as well. If one runner determines that he/she is unable/unwilling to complete his/her segment once the relay is in-process, a suitable replacement may be located. Similar to the initial transaction, all relevant parties would need to agree to accept the replacement runner. However, if a runner has already fulfilled his or her duty and has received payment, then that runner need not be required to agree to the replacement runner in the relay.

Alternatively, if a suitable replacement cannot be found and/or agreed upon, the current runner in possession of the package may be given the option to take the package to the next active runner in the chain, if the modification is agreed to by the customer. If this modification is not agreed to, or not possible for whatever reason, or if the option for this has been specifically excluded in the pre-transaction terms specified by the parties (maybe a runner wouldn't agree to a replacement just so he or she could modify the terms in his or her favor), then the system may provide additional options. In one option, the terms of the job can be modified so that the runner currently holding the package ships the package through a traditional service. In another example, the runner currently in possession of the package can hold the package until the customer is able to retrieve it. In further embodiments, for example, where the runner currently possessing the package cannot conveniently hold onto the package for much longer, the system may permit the runner to drop the package with another runner in the vicinity for a “pit-stop.” This new runner, to be agreed upon by all parties, will hold the package and be authorized to fulfill the contingencies of the job in a manner agreed to by all relevant parties—that is, in a manner consistent with the one of the aforementioned contingencies.

The above-described systems and methods may present customers and runners with a dynamic economy to which participants can compete for shipping jobs based on multiple factors. Runners may compete with other runners based on price, which may drive down costs for the customer. A customer can then choose which runner's offer they wish to accept, or allow multiple acceptable runners to bid for the job, accepting the best offer by the deadline of their choosing (like an auction). Runners may also compete with other runners based on qualitative and/or quantitative factors, based on their reviews or ratings, based on their travel routes, and/or based on their personal characteristics. Some competition may be directly influenced by the runners themselves, such as pricing or desirability of routes, and some competition may be indirect based on the innate characteristics or third party reviews of a runner.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A method comprising:
receiving a shipping need from a customer via a customer remote device connected over a communications network to a server system, the shipping need including a destination;
receiving spatiotemporal information for each of a plurality of runners via a plurality of runner remote devices coupled over a communications network to the server system;
generating one or more travel routes for each of the plurality of runners based, at least in part, on the spatiotemporal information;
identifying one or more customer opportunities for the shipping need, each of the customer opportunities being identified based, at least in part, on an intersection of at least a portion of the one or more travel routes and the destination, within a predetermined spatiotemporal deviation; and
selecting one of the one or more customer opportunities for fulfilling the shipping need.

2. The method of claim 1, wherein the shipping need further includes an origin.

3. The method of claim 2, wherein each of the customer opportunities is identified based, at least in part, on an intersection of least a portion of the one or more travel routes and one or both of the origin and the destination, within a predetermined spatiotemporal deviation.

4. The method of claim 1, wherein the shipping need further includes a desired time of delivery at the destination.

5. The method of claim 4, wherein each of the customer opportunities is identified based, at least in part, on an intersection of least a portion of the one or more travel routes and one or both of the destination and the desired time of delivery at the destination, within a predetermined spatiotemporal deviation.

6. The method of claim 1, further comprising:
providing to the customer, via the customer remote device, an indication of the customer opportunities; and
receiving from the customer, via the customer remote device, a selection of one of the one or more customer opportunities.

7. The method of claim 1, further comprising:
identifying runner opportunities, each of the runner opportunities being identified based, at least in part, on an intersection of at least a portion of the one or more travel routes of one of the plurality of runners and the destination, within a predetermined spatiotemporal deviation;
providing, to at least one of the plurality of runner remote devices, an indication of the one or more runner opportunities; and
receiving, from at least one of the plurality of runner remote devices, a selection of one of the one or more runner opportunities by at least one of the plurality of runners.

8. The method of claim 7, further comprising:
identifying runner endorsed opportunities, each of the runner endorsed opportunities comprising one of the runner opportunities selected by one of the plurality of runners;
providing to the customer, via the customer remote device, an indication of the runner endorsed opportunities; and
receiving from the customer, via the customer remote device, a selection of one of the runner endorsed opportunities.

9. The method of claim 1, further comprising:
receiving shipping needs from a plurality of customers via a plurality of customer remote devices connected over a communications network to a server system, each of the shipping needs including an origin and a destination;
generating one or more shipping routes between the origin and the destination of each of the shipping needs; and
identifying one or more customer opportunities for each of the shipping needs, each of the customer opportunities comprising one of the one or more travel routes that intersects one of the one or more shipping routes.

10. The method of claim 1, wherein the travel routes are further generated, at least in part, based on geospatial information, including known roadways, waterways, railways, pedestrian routes, bike routes, and public transit routes, a runner's mode of transportation, traffic conditions, weather conditions and elevation changes.

11. The method of claim 1, wherein the travel routes are further generated, at least in part, based on the runner's preference information.

12. The method of claim 11, wherein the runner's preference information includes the runner's preferred time of delivery at a shipping need destination, neighborhoods of origin, neighborhoods of destination, locations of origin, locations of destination, and cargo characteristics of a shipping need.

13. The method of claim 12, wherein the runner's preference information is generated based, at least in part, on historical data relating to shipping needs fulfilled by the runner.

14. The method of claim 11, wherein the runner's preference information includes the runner's historical consumer data, including genres of products or services purchased by the runner, franchises or stores at which a runner has purchased products or services, brands of products or services purchased by the runner, pricing of products or services purchased by the runner and times of day the runner purchased a product or service.

15. The method of claim 1, wherein the runner's spatiotemporal information is received by one or more of: being input by one of the plurality of runners, being imported from an electronic calendar, being imported from a software application capable of obtaining spatiotemporal information of one of the plurality of runners, and being gathered from a location tracking or navigation system device.

16. The method of claim 1, wherein the spatiotemporal information includes one or more of a time of day and the runner's appointments, schedule, known current location, predicted current location, known future location, historical location data, historical route data, approximate speed of travel and approximate direction of travel.

17. The method of claim 16, wherein the runner's historical location data includes locations previously visited by the runner, the number of times the locations were previously visited, and the days of the week and times of day the locations were previously visited.

18. The method of claim 1, wherein the travel routes are further generated based, at least in part, on a combination of two or more of a runner's spatiotemporal information, a runner's preference information, and geospatial information.

19. The method of claim 1, wherein the travel routes include an approximate start point and time, an approximate end point and time and one or more approximate intermediate points and times and wherein each of the customer opportunities is identified based, at least in part, on an intersection of the destination and at least one of the approximate start point and time, approximate end point and time and one of the one or more approximate intermediate points and times of a travel route, within a predetermined spatiotemporal deviation.

20. The method of claim 1, wherein the one or more customer opportunities are further identified based, at least in part on, one or more of the customer's preference information and preference information of a class of customers to which the customer belongs.

21. The method of claim 7, wherein the one or more runner opportunities are further identified based, at least in part, on one or more of the runner's preference information and preference information of a class of runners to which the runner belongs.

22. A server system coupled to a communications network, the server system configured to:
receive from a customer remote device connected over the communications network to the server system, one or more shipping needs, the shipping needs including a destination;
receive from each of a plurality of runner remote devices connected over a communications network to the server system, spatiotemporal information for each of a plurality of runners;
generate one or more travel routes for each of the plurality of runners based, at least in part, on the spatiotemporal information;
identify one or more customer opportunities for each of the one or more shipping needs, each of the customer opportunities being based, at least in part, on an intersection of at least a portion of the one or more travel routes and the destination, within a predetermined spatiotemporal deviation; and
select one of the one or more customer opportunities for fulfilling the shipping need.

23. The system of claim 22, wherein the server is further configured to:
provide to the customer remote device an indication of the one or more customer opportunities for each of the one or more shipping needs; and
receive from the customer remote device a customer opportunity selected from the one or more customer opportunities.

24. The system of claim 22, wherein the server is further configured to:
identify one or more runner opportunities for each of the plurality of runners, each of the runner opportunities being based, at least in part, on an intersection of at least a portion of the travel routes of each of the plurality of runners and the destination, within a predetermined spatiotemporal deviation;
provide to the plurality of runner remote devices an indication of the one or more runner opportunities for each of the plurality of runners; and
receive from the plurality of remote devices a runner opportunity selected from the one or more runner opportunities for each of the plurality of runners.

25. The system of claim 24, wherein the server is further configured to:
identify one or more runner endorsed opportunities, the runner endorsed opportunities comprising the one or more runner opportunities selected by the plurality of runners;
provide to the customer remote device an indication of the one or more runner endorsed opportunities for each of the one or more shipping needs; and
receive from the customer remote device a customer opportunity selected from the one or more runner endorsed opportunities.

26. The system of claim 22, wherein the server is further configured to:
receive shipping needs from a plurality of customers via a plurality of customer remote devices connected over the communications network to the server system, each of the shipping needs including an origin and a destination;
generate one or more shipping routes between the origin and the destination of each of the shipping needs; and
identify one or more customer opportunities for each of the shipping needs, each of the customer opportunities comprising one of the one or more travel routes that intersects one of the one or more shipping routes.

27. The system of claim 22, wherein the travel routes are further generated, at least in part, based on geospatial information, including known roadways, waterways, railways, pedestrian routes, bike routes, and public transit routes, a runner's mode of transportation, traffic conditions, weather conditions and elevation changes.

28. The system of claim 22, wherein the travel routes are further generated, at least in part, based on the runner's preference information.

29. The system of claim 28, wherein the runner's preference information includes the runner's preferred time of delivery at a shipping need destination, neighborhoods of origin, neighborhoods of destination, locations of origin, locations of destination, and cargo characteristics of a shipping need.

30. The system of claim 29, wherein the runner's preference information is generated based, at least in part, on historical data relating to shipping needs fulfilled by the runner.

31. The system of claim 28, wherein the runner's preference information includes the runner's historical consumer data, including genres of products or services purchased by the runner, franchises or stores at which a runner has purchased products or services, brands of products or services purchased by the runner, pricing of products or services purchased by the runner and times of day the runner purchased a product or service.

32. The system of claim 22, wherein a runner's spatiotemporal information is received by one or more of: being input by a runner, being imported from an electronic calendar, being imported from a software application capable of obtaining the spatiotemporal location of a runner, and being gathered from a location tracking or navigation device.

33. The system of claim 22, wherein the spatiotemporal information includes one or more of a time of day and the runner's appointments, schedule, known current location, predicted current location, known future location, historical location data, historical route data, approximate speed of travel and approximate direction of travel.

34. The system of claim 33, wherein a runner's historical location data includes locations previously visited by the runner, the number of times the locations were previously visited, and the days of the week and times of day the locations were previously visited.

35. The method of claim 22, wherein the travel routes are further generated based, at least in part, on a combination of two or more of a runner's spatiotemporal information, a runner's preference information, and geospatial information.

36. The method of claim 22, wherein the one or more customer opportunities are further identified based, at least in part on, one or more of the customer's preference information and preference information of a class of customers to which the customer belongs.

37. The method of claim 24, wherein the one or more runner opportunities are further identified based, at least in part, on one or more of the runner's preference information and preference information of a class of runners to which the runner belongs.

38. A shipping method comprising:
receiving a shipping need from a customer via a customer remote device connected over a communications network to a server system, the shipping need including a destination;
receiving, via a plurality of runner remote devices coupled over a communications network to the server system, at least one approximate current location and at least one approximate future location for each of a plurality of runners;
identifying one or more intersections between at least one of a shipping need destination, a runner current location and a runner future location; and
identifying a customer opportunity for each of the one or more shipping needs based, at least in part, on the one or more intersections.

39. The shipping method of claim 38, wherein an intersection occurs when a shipping need destination falls within a predetermined deviation in travel time or geographical distance from either or both of a runner approximate current location and a runner approximate future location.

40. The shipping method of claim 38, further comprising:
generating one or more travel routes for each of a plurality of runners based, at least in part, on the at least one approximate current location and at least one approximate future location of each of the plurality of runners;
identifying one or more intersections of at least a portion of the one or more travel routes and the destination; and
identifying a customer opportunity for each of the one or more shipping needs based, at least in part, on the one or more intersections.

41. The shipping method of claim 40, wherein an intersection occurs when the destination falls within a predetermined deviation in travel time or geographical distance from one of the one or more runner travel routes.
